(19) United States
(12) Patent Application Publication
(10) Pub. No.: US 2005/0093946 A1
(43) Pub. Date: May 5, 2005

(54) Drum printer with spittoon and method for servicing

(76) Inventors: Christopher S. Tanner, La Mesa, CA (US); Robert W. Beauchamp, Carlsbad, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,129

(22) Filed: Nov. 3, 2003

(51) Int. Cl. B41J 2/185

(52) U.S. Cl. 347/90

(57) ABSTRACT

A drum printer includes a rotatable drum having an aperture formed in a drum surface, and a printhead. Fluid is spit from the printhead into the aperture.

### BACKGROUND

Drum printers are a type of printing system including a rotating drum for moving media under a printing device such as an array of fluid ejecting elements. The fluid ejecting elements can include inkjet printheads, and typically may need servicing from time to time. Accessing the printheads for servicing presents a problem.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an isometric view of an embodiment of a drum printer in accordance with an aspect of the invention.

FIG. 2 is an isometric view illustrating an embodiment of a print bar for the drum printer of FIG. 1.

FIG. 3 is a diagrammatic partial side cross-sectional view illustrating the rotatable drum of FIG. 1, showing a plurality of print bars in printing position and a spittoon slot in the drum for receiving ink spit from a print bar during a service mode.

FIG. 4 is a schematic block diagram of an exemplary spittoon vacuum system for a drum printer.

FIG. 5 is a partial cross-sectional diagram of a drum and support bearing arrangement, showing a vacuum interconnect arrangement.

FIG. 6 is a schematic block diagram of the control system for the drum printer.

### DETAILED DESCRIPTION OF THE DISCLOSURE

In the following detailed description and in the several figures of the drawing, like elements are identified with like reference numerals.

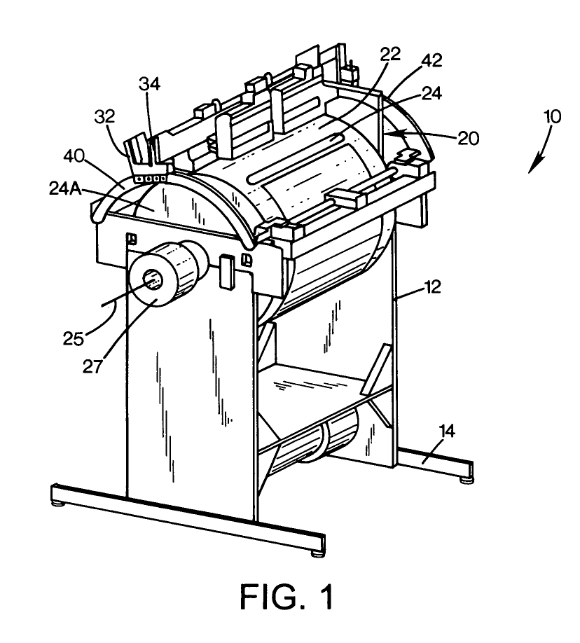

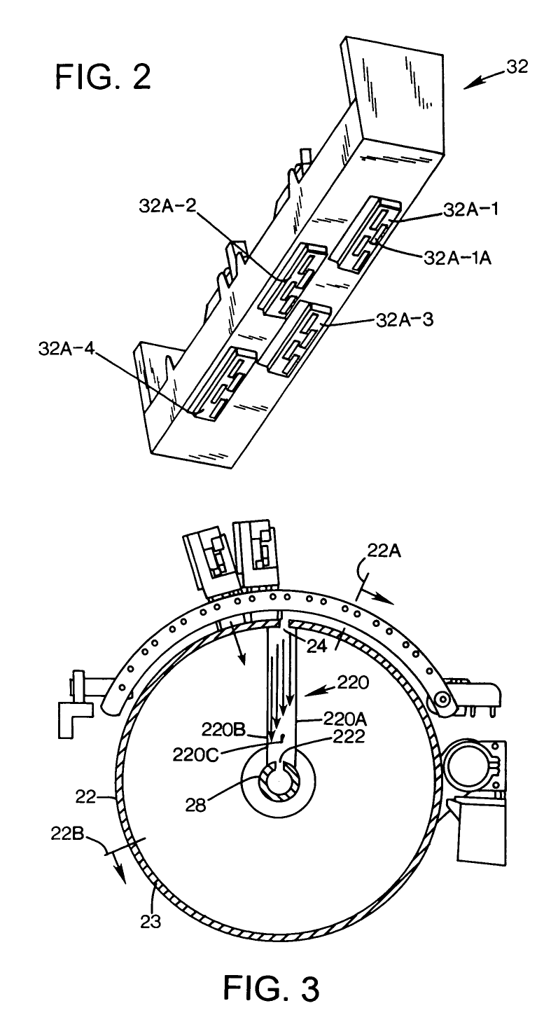

FIG. 1 is a simplified isometric view of an exemplary embodiment of a drum printer 10, comprising a frame structure 12 supporting a rotatable hollow drum 20, with a plurality of print bars disposed adjacent the outer surface of the drum. The printer frame is mounted on a pair of legs 14. The drum 20 comprises a cylindrical wall 22 and first and second end plates secured in a perpendicular manner to the drum wall at respective ends thereof. End plate 24A is visible in the isometric view of FIG. 1. The end plates are attached to a hollow axle 28 (FIG. 2), which is bearing mounted for rotation about a drum axis of rotation 25.

In this exemplary embodiment, the printer uses sheets of print media, although other types of print media, e.g. card stock, could alternatively be used. The print media is advanced onto the drum surface, and held in place by a media hold-down system, e.g. a vacuum acting through an array of holes formed through the cylindrical drum wall 22, an electrostatic hold-down system, or a mechanical hold-down system.

For simplicity, only two print bars 32,34 are shown in FIG. 1, but embodiments of the drum printer can include a single print bar, or more than two print bars. In an exemplary embodiment, the printer has six print bars, the outer print bars for ejecting drops of fixer fluid, the intermediate four print bars for ejecting drops of four different ink colors for a full color printer.

Each print bar comprises in one exemplary embodiment a page wide array (PWA) of printheads or pens. In this exemplary embodiment the printheads are inkjet printheads, each comprising one or more arrays of fluid ejecting nozzles. In an exemplary embodiment, each print bar supports a plurality of printheads, disposed along the width of the page. Moreover, each print bar can support printheads of the same color in an exemplary embodiment. For example, print bar 32 can support yellow ink ejection devices, print bar 34 can support black ink ejection devices, another print bar (not shown in FIG. 1) can support cyan ink ejection devices, and another print bar (not shown in FIG. 1) can support magenta ink ejection devices. In another embodiment, a print bar can have printheads with multiple colors of ink.

FIG. 2 is an isometric view of an exemplary print bar 32, which has mounted therein four printhead cartridges or modules 32A-1, 32A-2, 32A-3, 32A-4, each with an associated printhead nozzle array. In this exemplary embodiment, each cartridge includes a set of four nozzle arrays which are arranged in a staggered relationship. For example, printhead 32A-1 includes an array 32A-1A of nozzle arrays. The printhead cartridges are arranged along an extent of the print bar in a distributed, staggered manner so as to provide full coverage along the extent of a print zone. In an exemplary embodiment, each of the print cartridges can be fed with ink through flexible tubes running to ink supplies located off the print bar. Alternatively, the print cartridge can include on-board ink reservoirs with capacity sufficient to print one or more print jobs.

In this exemplary embodiment, each exemplary print bar is supported at each end thereof by arcuate print bar frame supports 40, 42 (FIG. 1). In some embodiments, each frame support is secured to frame 12 such that a radius of curvature of the frame supports is substantially coincident with the axis of rotation 25 of the drum 20.

During printing operations, in an exemplary embodiment, a sheet of print media is loaded onto the drum surface, and the drum 22 is rotated with the print bars held in their stationary, printing positions. As the print media is passed below the print bars, the printheads carried by the print bars are energized in a controlled manner to eject drops of ink or other fluid, e.g. a fixer fluid, onto the print media surface. In an exemplary embodiment, the drum has a diameter of 16 inches, and is rotated at a rate such that the print medium is passed by the print bars at 20 inches per second, with a print resolution of 600 dots per inch (dpi), and with a printhead firing rate of 12 kHz. Other rates and configurations may, of course, be alternatively employed. In this embodiment, the drum may be rotated at a constant velocity during printing to provide improved print quality. In other embodiments, the print bars may have less than page width coverage, and the print cartridges or modules on the print bars may be incrementally moved along a print bar axis as the drum spins.

The drum cylindrical wall 22 has formed therein a spittoon aperture 24, which in this exemplary embodiment is a slot, which is aligned with the longitudinal extent of the respective print bars; in this exemplary embodiment, the slot is parallel to the axis 25 of rotation of the drum 20. The slot 24 has a width spanning all printhead arrays on a print bar, although this may vary depending on the parameters of a particular implementation. In one exemplary embodiment, the spittoon slot width is in the range of 5 mm to 10 mm. In another exemplary embodiment, the aperture 24 has a longitudinal extent at least as long as a longitudinal extent of a printhead nozzle array, wherein the longitudinal extent is in a direction generally parallel to the drum axis of rotation 25

In this exemplary embodiment, a spittoon duct 220 is fabricated within the drum cylinder 20 between the spittoon slot 24 and the axle 28. In an exemplary embodiment, the duct comprises solid walls 220A, 220B formed between the end plates, and thus defining a channel or duct 220C for carrying air and ink droplets and aerosol between the slot and the axle. The axle 26 has an opening 222 or array of openings formed there through in a region between the duct walls, and is connected to a source of vacuum through a vacuum hose interconnect 27 (FIG. 1) which connects to an open end of the axle. The distal end of the axle is closed. Thus, the vacuum source creates a vacuum, drawing air and ink droplets and aerosol through the slot, into the duct 220, out the hollow axle 28. The vacuum pressure at the slot can vary, e.g. between 1 inch of water to 20 inches of water. In one exemplary embodiment, a vacuum pressure on the order of 2 inches of water provided a satisfactory operation.

In other embodiments, the spittoon duct 220 may be omitted, and air, ink droplets and aerosol are drawn into the interior of the drum cylinder by the vacuum drawn through the axle openings 222.

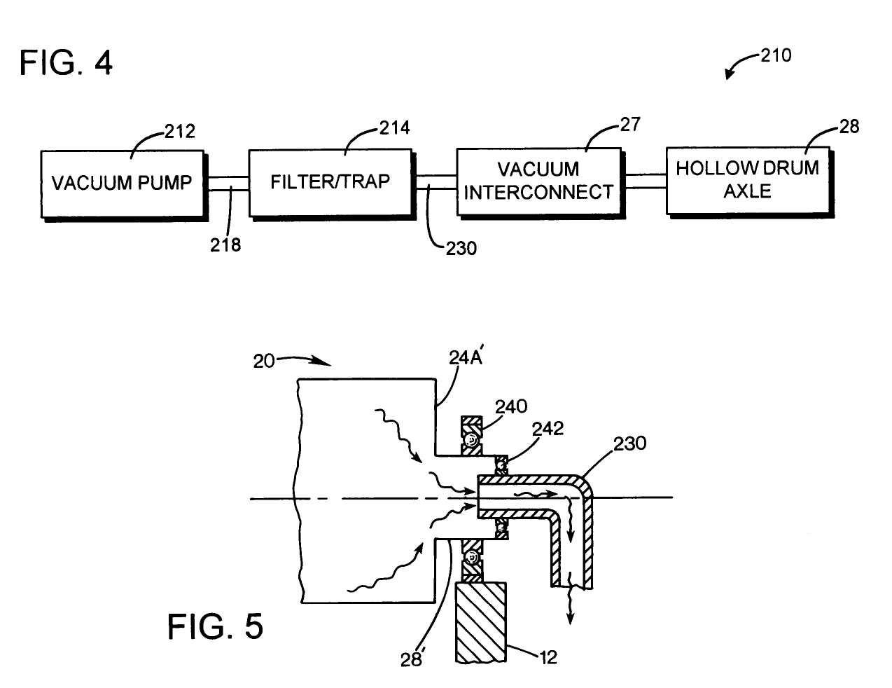

FIG. 4 is a schematic block diagram showing the spittoon vacuum system 210 for the drum printer. A source of vacuum, e.g. a vacuum pump 212 is connected to the hollow drum axle 28 through a replaceable filter or trap 214, and hoses or conduits 218 and 230. The vacuum interconnect 27 provides a connection from conduit 230 to the hollow axle 28.

In an exemplary embodiment, the print media is loaded onto the drum cylinder over a media supporting surface portion, e.g. surface portion 23 (FIG. 3) between lines 22A and 22B (FIG. 3), sometimes referred to hereinafter as a platen surface. The magnitude of the media supporting surface portion may be application-specific. However, this surface portion does not extend over the spittoon slot 26 in an exemplary embodiment, so that the print media does not cover the slot during printing operations conducted by the printer 10. This facilitates printhead servicing “on the fly,” i.e. during printing operations on a print media. Thus, the drum cylinder is brought to a constant rotational speed. During periods of time in which the print media is passed through the print zones below the print bars, the printheads carried by the print bars are selectively activated to eject ink droplets, fixer, or both to create a desired image onto the print media. When the spittoon slot passes below the print bars, the nozzle arrays on the respective print bars are activated to spit ink droplets into the spittoon slot passing below. This is done to maintain printhead health. For example, each nozzle can be fired five to ten times during a spitting cycle. In an exemplary embodiment, the spittoon slot has a width about the same width as a printhead nozzle array, although this can be wider or smaller for different applications. Thus, in this exemplary embodiment, for each rotation of the drum cylinder, there is a printing cycle and a spitting cycle.

To collect the ink droplets and reduce aerosol buildup, a vacuum is applied to the spittoon slot 26, as described above, through a vacuum line connected to hollow axle 28 which draws air through the slot 26 and the openings formed in the cylinder wall 22, through the axle to the replaceable ink filter or trap 214 for easy disposal.

FIG. 5 is a diagrammatic partial cross-sectional diagram of a drum and double bearing support with a vacuum interconnect according to an example embodiment. In this embodiment, the duct 220 and hollow axle 28 extending into the interior of the hollow drum in the embodiment illustrated in FIGS. 1-3 have been omitted. The side plates have formed therein protruding axle stubs, e.g. plate 24A′ has axle stub 28′ protruding therefrom. The axle stubs are bearing mounted on a support bearing structure mounted to the frame 12; for example, axle stub 28′ is bearing mounted for rotation on support bearing 240. The axle stub 28′ in this embodiment is hollow, and has mounted therein a vacuum tube support bearing 242 for receiving vacuum conduit 230, and permitting axle stub 28′ to rotate while the vacuum conduit 220 remains stationary.

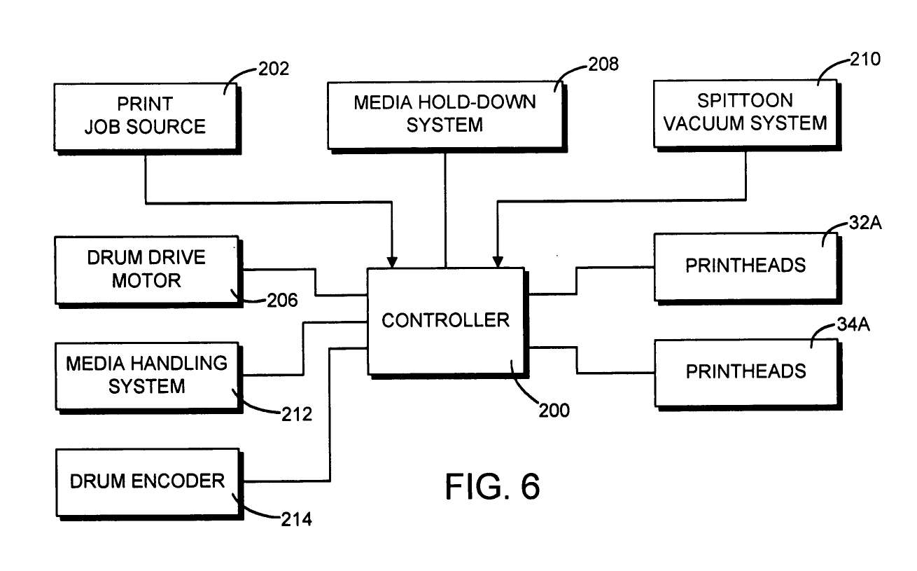

FIG. 6 is a schematic block diagram of the control system for the exemplary printer. A controller 200, such as a microcomputer or ASIC, receives print job commands and data from a print job source 202, which can be a personal computer, scanner, digital camera or other known source of print jobs. The controller acts on the received commands to activate a media handling system 212 to load a print medium onto the drum 20 and activate the media hold-down system 208 to hold the print medium against the drum surface. The drum drive motor 206 is commanded by the controller to start rotating the drum, and bring it to a constant rotational speed. The print job then commences. Firing pulses are sent to the printheads comprising the print bars including printheads 32A, 34A to eject droplets onto the medium surface. As the spittoon slot passes the print bars, the printheads are activated to spit drops into the spittoon slot. The media handling system unloads the print medium from the drum upon completion of printing. A drum encoder system 214 provides drum position information to the controller to allow the controller to maintain accurate positioning and rotating of the drum.

Although the foregoing has been a description and illustration of specific embodiments of the invention, various modifications and changes thereto can be made by persons skilled in the art without departing from the scope and spirit of the invention as defined by the following claims.

1. A method for servicing a printhead, the method comprising:
rotating a drum, the drum having an aperture defined in a drum surface;
spitting fluid from the printhead into the aperture.

2. The method of claim 1, further comprising:
drawing the fluid spit from the printhead through the aperture into a collection structure.

3. The method of claim 2, wherein said drawing the fluid spit from the printhead into a collection structure comprises:
drawing said fluid through a duct channel having a channel opening at the aperture and into the collection structure.

4. The method of claim 1, further comprising:
creating a vacuum between the slot and a fluid collection structure to draw the fluid spit from the printhead into the aperture into the fluid collection structure.

5. The method of claim 1, wherein said drum is rotating at a constant rotational rate while spitting fluid from the printhead.

6. The method of claim 1, wherein said printhead is mounted in a stationary position.

7. A drum printer, comprising:
a rotatable drum having a drum cylindrical wall including a print medium supporting surface portion;
a printhead disposed adjacent the supporting surface for ejecting fluid droplets; and
a spittoon aperture formed through the cylindrical wall at a drum service portion separated from the print medium supporting surface portion, the aperture having a longitudinal extent at least as long as a longitudinal extent of said printhead.

8. The printer of claim 7, further comprising a print bar comprising a page wide array of printheads.

9. The printer of claim 7, wherein said printhead comprises an array of fluid ejecting nozzles.

10. The printer of claim 9, wherein said array of fluid ejecting nozzles is positioned adjacent to the surface of the drum to provide high print quality of the printed output.

11. The printer of claim 7, further comprising a vacuum system coupled to the drum to draw fluid drops through the spittoon aperture into the drum and to a collection structure.

12. The printer of claim 11, wherein the vacuum system includes a hollow drum axle disposed within the drum cylindrical wall and a duct fixed between the drum axle and the drum cylinder, the duct communicating with the spittoon aperture, and wherein the drum axle has one or more openings formed therein in communication with the duct.

13. The printer of claim 12, wherein the vacuum system further includes a vacuum source coupled to the hollow drum axle through a vacuum conduit.

14. The printer of claim 13, wherein the collection structure comprises a filter or ink trap coupled to the vacuum conduit.

15. The printer of claim 11, wherein the drum is supported for rotation on a bearing structure, and said vacuum system includes a vacuum conduit connected to said drum by a conduit bearing support permitting the drum to rotate and the vacuum conduit to remain in a fixed position.

16. The printer of claim 7, further comprising a mounting structure for mounting the printhead in a fixed position relative to the drum cylindrical wall.

17. A drum printer, comprising:
a rotatable drum having a drum cylindrical wall including a print medium supporting surface portion;
means for rotating the drum about a drum axis;
fluid ejecting means disposed adjacent the drum cylindrical wall for ejecting fluid drops, said fluid ejecting means having a page wide extent; and
a spittoon slot formed through the cylindrical wall at a drum service portion separated from the print medium supporting surface portion, said spittoon slot having an extent at least as long as said page wide extent.

18. The printer of claim 17, wherein said spittoon slot is parallel to said drum axis.

19. The printer of claim 17, wherein said fluid ejecting means comprises a page wide array of printheads.

20. The printer of claim 17, further comprising a vacuum means for drawing fluid drops ejected by the fluid ejecting means through the spittoon slot into the drum and to a collection structure.

21. The printer of claim 17, further comprising a frame structure for mounting the fluid ejecting means in a fixed position relative to the drum cylindrical wall.

22. A method comprising:
with a print medium on a drum, rotating the drum,, the drum having a through hole defined through a drum surface;
ejecting fluid drops onto the print medium;
as the through hole passes through the print zone, spitting fluid into the through hole.

23. The method of claim 22, further comprising:
drawing the fluid spit into the through hole to a collection structure.

24. The method of claim 23, wherein said drawing the fluid spit into the through hole to a collection structure comprises:
drawing said fluid through a duct channel having a channel opening at the through hole and into the collection structure.

25. The method of claim 22, wherein said ejecting fluid drops onto the print medium comprises:
ejecting fluid drops from a page wide array of printheads, each comprising an array of fluid ejecting nozzles.

26. The method of claim 22, wherein said drum is rotated at a constant speed during said ejecting fluid drops onto the print medium, and said spitting drops into the through hole.

27. The method of claim 22, wherein said spitting fluid into said through hole includes:
spitting fluid into the through hole without changing a rotational speed of said drum.

28. A method for operating a drum printer, the method comprising:
rotating a drum at a constant rotational rate, the drum having an aperture formed therein;
for a rotation of the drum during an operating time:
conducting a printing operation by ejecting fluid drops from a printhead onto the print medium as the print medium passes through a print zone;
as the aperture passes through the print zone, conducting a printhead service operation by spitting fluid from the printhead through the aperture.

29. The method of claim 28, further comprising:
drawing fluid drops spit from the printhead through the aperture into a collection structure.

30. The method of claim 29, wherein said drawing fluid drops spit from the printhead into the collection structure comprises:
creating a vacuum between the slot and the collection structure to draw the fluid spit from the printhead into the aperture into the collection structure.

31. The method of claim 28, wherein said conducting a printing operation further comprises ejecting fluid drops from a page wide array of printheads, each comprising an array of fluid ejecting nozzles.

32. The method of claim 28 wherein said printhead is held in fixed position relative to the drum while the drum is rotating.

33. A drum printer, comprising:
a rotatable drum having a drum cylindrical wall including a print medium supporting surface portion;
a printhead disposed adjacent the supporting surface for ejecting fluid droplets;
a spittoon aperture formed through the cylindrical wall at a drum service portion separated from the print medium supporting surface portion;
a duct in said drum cylindrical wall having a spittoon end opening to said spittoon aperture and a second end communicating with a source of vacuum.

34. The printer of claim 33, wherein the aperture has a longitudinal extent at least as long as a longitudinal extent of said printhead.

35. A method for servicing a printhead, the method comprising:
rotating a drum about a rotation axis, the drum having a spittoon slot defined in a drum service;
conducting a printhead service operation by spitting fluid from the printhead through the spittoon slot.

36. The method of claim 35, further comprising:
drawing the fluid spit from the printhead through the spittoon slot into a collection structure.

37. The method of claim 35, further comprising:
creating a vacuum between the slot and a fluid collection structure to draw the fluid spit from the printhead through the spittoon slot into the fluid collection structure.

38. The method of claim 35, wherein said drum is rotating at a constant rotational rate while conducting said printhead service operation.

39. A method for servicing a print bar, the method comprising:
with a print medium loaded onto a print medium supporting surface portion of a drum, rotating the drum about a rotation axis, the drum having a spittoon slot defined through a drum surface at a service position spaced from the print medium supporting portion;
ejecting fluid drops from the print bar onto the print medium as the print medium is passed through a print zone for the print bar;
as the spittoon slot passes through the print zone, conducting a printhead service operation by spitting fluid from the print bar through the spittoon slot.

40. The method of claim 39, further comprising:
drawing the fluid spit from the print bar through the spittoon slot into a collection structure.

41. The method of claim 39, further comprising:
creating a vacuum between the slot and an ink collection structure to draw the fluid spit from the printhead through the spittoon slot into the fluid collection structure.

42. The method of claim 39, wherein said print bar is a page wide array of printheads, each comprising an array of fluid ejecting nozzles.

43. The method of claim 39, wherein said drum is rotated at a constant speed during said ejecting fluid drops from the print bar onto the print medium, and said conducting a printhead service operation.
